(19) United States
(12) Patent Application Publication
(10) Pub. No.: US 2006/0027106 A1
(43) Pub. Date: Feb. 9, 2006

(54) Apparatus and method for preparing multiple pizzas

(76) Inventors: Todd Craig, Plano, TX (US); Peter Graham, Lucas, TX (US); Homero Ortegon, Carrollton, TX (US); Diana McCown, Lewisville, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/775,753

(22) Filed: Feb. 10, 2004

Related U.S. Application Data
(60) Provisional application No. 60/446,479, filed on Feb. 10, 2003.

(51) Int. Cl. A47J 39/00

(52) U.S. Cl. 99/448

(57) ABSTRACT

An apparatus for holding multiple pizzas includes a pan and an insert adapted to fit within the pan. The insert includes a plurality of sidewalls extending between a base of the insert and an upper portion of the insert, and the sidewalls generally surround a plurality of openings defined by the insert in the base. The insert is adapted to fit within the pan such that each of the multiple pizzas contacts a bottom of the pan and the sidewalls of the insert. A method of making multiple pizzas includes placing a support into a cooking vessel, placing dough across the support to form multiple dough portions, placing ingredients on the multiple dough portions to form multiple pizzas, and placing the support and the cooking vessel into a heating environment to bake the multiple pizzas.

### CROSS-REFERENCE TO RELATED APPLICATIONS

The subject matter of this patent application is related to the subject matter of U.S. Provisional Patent Application No. 60/446,479, filed Feb. 10, 2003, priority to which is claimed under 35 U.S.C. § 119(e) and which is incorporated herein by reference, and the subject matter of this patent application is also related to the subject matter of U.S. Design Patent Application No. ______ (Attorney Docket No. P350.122.101), filed Feb. 10, 2004, which is incorporated herein by reference.

### BACKGROUND OF THE INVENTION

Pizza is one of the most popular food items in the United States. Pizzas come in many different shapes and sizes, with virtually unlimited variation in the types of toppings, meats, vegetables, cheese, doughs/crusts and other ingredients used. Pizza makers select and assemble these ingredients to create a taste, aroma, texture and consistency in accordance with the desires of their selected audience. Commercial pizza makers with national and international presence, especially pizza restaurants, typically select, develop and promote a number of different pizzas, varying at least in the number and type of toppings.

So that one or more consumers can enjoy different styles or types of pizzas in one sitting, it is often desired to provide pizzas made-to-order in one way on one portion of the pizza, and in another way on another portion of the pizza. A customer or group customers in a pizza restaurant, for example, might order one topping on one-half of the pizza and another topping on another half of the pizza. Potential difficulties arise, however, in that different topping types may not be distributed or maintained exactly as desired. For example, one topping type intended for one portion of the pizza may spill over to the other portion of the pizza when the pizza is made, or toppings may slide off their intended portion of the pizza when the pizza is cut. Additionally, pizza may not be cut exactly at the division line between the differently prepared portions. It can also be operationally difficult to combine certain pizza variations into a single pizza.

### SUMMARY OF THE INVENTION

An apparatus for holding multiple pizzas includes a pan and an insert adapted to fit within the pan. The insert includes a plurality of sidewalls extending between a base of the insert and an upper portion of the insert, and the sidewalls generally surround a plurality of openings defined by the insert in the base. The insert is adapted to fit within the pan such that each of the multiple pizzas contacts a bottom of the pan and the sidewalls of the insert. A method of making multiple pizzas includes placing a support into a cooking vessel, placing dough across the support to form multiple dough portions, placing ingredients on the multiple dough portions to form multiple pizzas, and placing the support and the cooking vessel into a heating environment to bake the multiple pizzas.

### BRIEF DESCRIPTION OF THE DRAWINGS

Embodiments of the invention will be described with respect to the figures, in which like reference numerals denote like elements and in which:

FIG. 1 is a perspective view of an apparatus for holding multiple pizzas, according to an embodiment of the invention.

FIG. 2 is a side view of a pan insert, according to an embodiment of the invention.

FIG. 3 is a top view of a pan insert, according to an embodiment of the invention.

FIG. 4 is an end view of a pan insert, according to an embodiment of the invention.

FIG. 5 is a perspective view showing dough being placed into the FIG. 1 apparatus, according to an embodiment of the invention.

FIG. 6 is a perspective view showing division of the FIG. 5 dough, according to an embodiment of the invention.

FIG. 7 is a perspective view showing a saucing process, according to an embodiment of the invention.

FIG. 8 is a perspective view showing an ingredient layer, according to an embodiment of the invention.

FIG. 9 is a perspective view showing multiple pizzas, according to an embodiment of the invention.

FIG. 10 is a perspective view showing multiple pizzas being conveyed into an oven, according to an embodiment of the invention.

FIG. 11 is a perspective view of multiple pizzas, according to an embodiment of the invention.

FIG. 12 is a perspective view showing cutting of the FIG. 11 pizzas, according to an embodiment of the invention.

FIG. 13 is a perspective view of a composite pizza formed of the FIG. 11 pizzas, according to an embodiment of the invention.

FIG. 14 is a perspective view of an apparatus for holding multiple pizzas, according to an embodiment of the invention.

### DETAILED DESCRIPTION

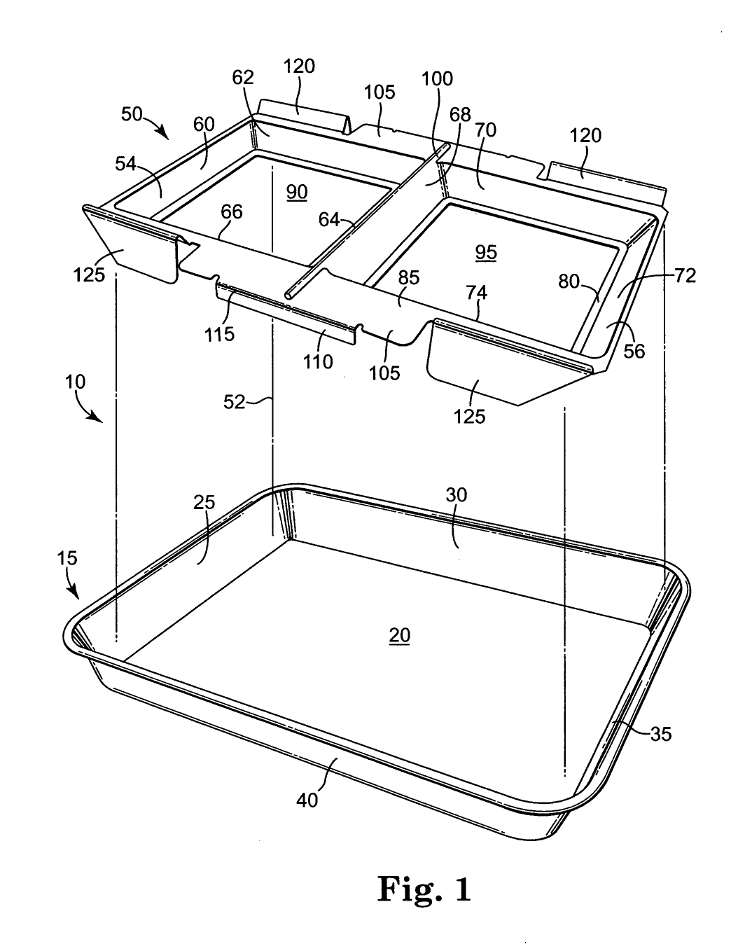

FIGS. 1-4 illustrate apparatus 10 for holding multiple pizzas or other food products. Apparatus 10 comprises pan 15 having bottom 20. Pan 15 is a standard generally rectangular baking pan, according to the illustrated embodiment, i.e. a pan that many pizza restaurants typically have on-hand as a stock item for bread sticks or other food items. Bottom 20 is generally rectangular and generally flat, as illustrated. Pan 15 also includes upstanding sidewalls 25, 30, 35, 40 defining four corners between them. It should be understood that shapes other than generally rectangular are contemplated, for example generally circular, generally square, generally triangular, generally polygonal, generally trapezoidal, etc. Pan 15 is constructed of aluminum, steel, or other heat-conducting metal or material, according to embodiments of the invention.

Apparatus 10 further comprises frame, or insert, 50. Insert 50 is adapted to fit within pan 15, as indicated by lines 52. Insert 50 is divided into two portions, or divisions, 54, 56. Portion 54 includes a plurality of sidewalls 60, 62, 64, 66, and portion 56 includes a plurality of sidewalls 68, 70, 72, 74. The sidewalls of insert 50 extend between a base plane or base 80 of insert 50 and an upper portion or plane 85 of insert 50. The sidewalls generally border or surround a plurality of openings 90, 95 defined in base 80 by insert 50. Insert 50 is adapted to fit within pan 15 such that each of the multiple pizzas or other food products contacts bottom 20 of pan 15 and the sidewalls of insert 50. Further, sidewalls of insert 50 are angled with respect to base 80 and upper portion 85 such that dough located within portions 54, 56, for example a single dough sheet that has settled into portions 54, 56, as will be described, is upturned and angled in a manner to provide a “separate-pizza” appearance, i.e. to create an appearance of multiple, separately prepared pizzas in the finished, baked product, each pizza having four crust edges. According to one particular embodiment, the obtuse angle formed between each of the sidewalls of insert 50 and base 80 is about 122 degrees, although other angles are also contemplated.

Insert 50 defines a generally rectangular shape, as illustrated. Openings 90, 95 are two in number, are of a generally square shape, and are for forming two generally square pizzas, in the illustrated embodiment. Other embodiments of the invention contemplate other shapes for insert 50, e.g. shapes corresponding to the shape of pan 15. As with pan 15, generally circular, generally square, generally triangular, generally polygonal, generally trapezoidal, etc. shapes are contemplated for insert 50. Further, as with pan 15, insert 50 is constructed of aluminum, steel, or other heat-conducting metal or material, according to embodiments of the invention. Insert 50 optionally is stamped from a single piece of metal so as to be one piece. Alternatively, insert 50 is extruded, molded, or otherwise formed to be a single piece. Additionally, insert 50 optionally includes any desired number of openings in base 80, for example four openings, six openings, eight openings, or any other desired number. The number of openings generally corresponds to the number of pizzas or other food products contemplated for production, but other ratios of food product to opening also are contemplated.

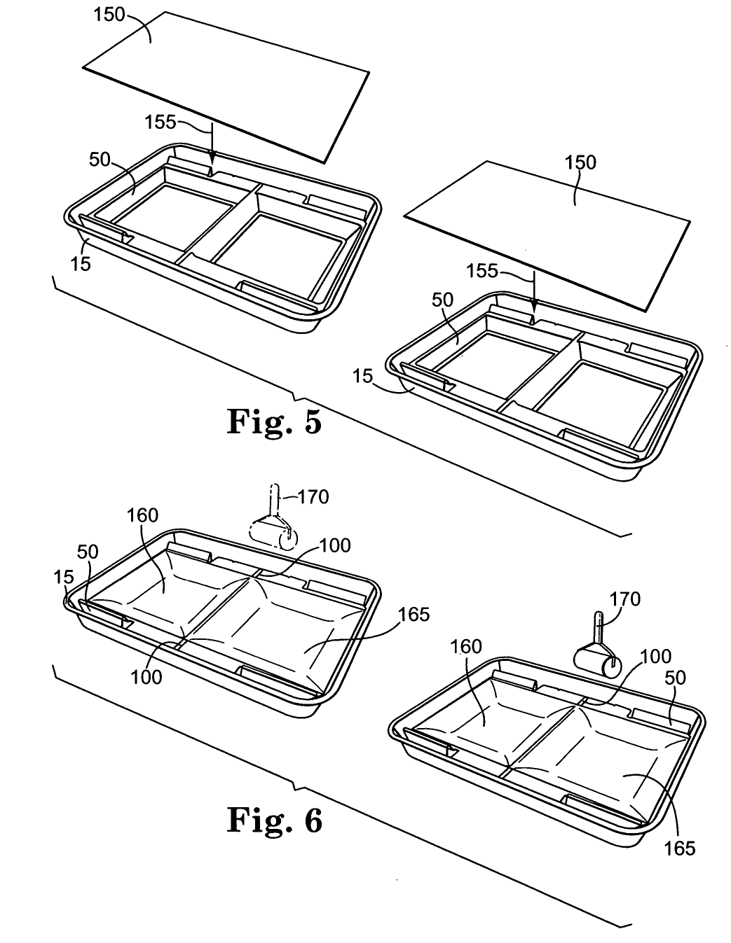

Insert 50 defines center bar 100 disposed above upper portion 85 of insert 50. As will be described with reference to FIGS. 5 and following, center bar 100 and the sidewalls of insert 50 are arranged such that a single sheet of dough laid across insert 50 is readily divided along center bar 100 to form separate crusts for the multiple pizzas. Center bar 100 is illustrated with a rounded upper surface designed to promote division, i.e. cutting or separation, of dough laid across it. Angled or other upper surfaces for center bar 100 also are contemplated.

Insert 50 also defines a generally planar platform 105 extending in upper portion 85 outwardly from the sidewalls of insert 50. Platform 105 is disposed on opposite sides and opposite ends of center bar 100; insert 50 as illustrated in FIG. 1 thus also can be considered to include two or four separate platforms, one (or two) each on either side of center bar 100, and one (or two) each on either end of center bar 100. As will be described, platform 105 provides back pressure against a roller or other device used to divide or contact dough laid across center bar 100. Extending along edge 115 of platform 105 is lip 110, which extends toward base 80 and is intended to structurally strengthen insert 50, i.e. to generally prevent or inhibit bending of insert 50 along center bar 100 absent excessive force. Insert 50 includes two lips 110, one adjacent each end of center bar 100.

Insert 50 also defines a plurality of dough guides 120 adapted to generally center or otherwise position dough laid across insert 50. Dough guides 120 extend above upper portion 85. Dough guides 120 define generally angled or ramped surfaces that serve to maintain dough placed across insert 50 in a desired position in the widthwise (front-to-rear) direction as viewed in FIG. 1. In the lengthwise (left-to-right) direction as viewed in FIG. 1, sidewalls 25, 35 of pan 15 generally serve to center or maintain the dough in a desired position. Dough guides 120 are especially desirable in the situation where dough is placed onto insert 50 in a generally frozen state, and then moved to a cooler or other second location for tempering, or thawing. Once the dough begins to temper, or has tempered, it settles into insert 50 and is more difficult to reposition. Dough guides 120 help ensure proper positioning of the dough before the tempering process begins. Dough guides 120 are positioned with respect to the remainder of insert 50 in a manner to accommodate the largest size of dough expected to be used, e.g. the largest spec tolerance envisioned being received from a dough vendor. In certain cases, end-to-end dough tolerances in vendor-sourced dough are tighter than side-to-side tolerances, so the degree of tolerance accommodated by the ramped portion of dough guides 120 is correspondingly greater than the degree of tolerance accommodated by sidewalls 25, 35 at the ends of pan 15.

Stabilizers 125 extend from dough guides 120 toward base 80. Stabilizers 125 are spaced from the sidewalls of insert 50 and are adapted to contact bottom 20, and/or sidewalls 25, 30, 35, 40, of pan 15. Stabilizers 125 generally prevent rocking or wobbling of insert 50 within pan 15, for example when a roller or other tool is placed in contact with dough on top of insert 50, or when other external force or motion is imparted to insert 50 and/or pan 15. Outer ends of stabilizers 125 are angled, as illustrated, to reduce or generally eliminate interference with pan 15.

Thus, according to embodiments of the invention, apparatus 10 can be considered to include frame 50 for supporting multiple food products, such as pizzas. Frame 50 defines a rim, e.g. including the previously described sidewalls, the rim generally surrounding a plurality of separated bottom openings 90, 95, one opening for each of the multiple food products. Openings 90, 95 are for transmission of thermal energy to the multiple food products supported by the rim. Frame 50 is adapted for placement within pan 15 to directly support the multiple food products through the bottom openings 90, 95. Center bar 100, and/or sidewalls 64, 68, define a cross-member or raised portion extending across frame 50 between bottom openings 90, 95 and is adapted to aid in cutting dough laid on frame 50.

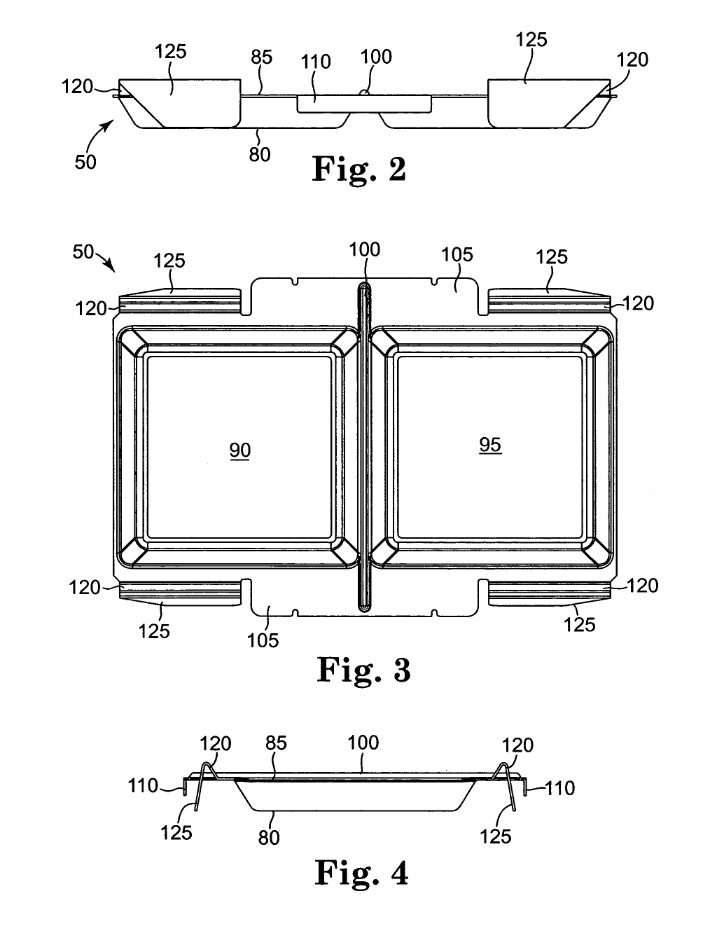

As will be appreciated from e.g. the side view of FIG. 2, inserts 50 according to embodiments of the invention are shaped such that multiple inserts nest one within the other to form a stack of inserts. Multiple inserts thus are stored in a relatively compact, relatively secure stack, if desired.

Those of ordinary skill will also appreciate that a wide variety of dimensions are contemplated according to embodiments of the invention. According to one example, a length of insert 50 is about 12 inches, more specifically about 12.19 inches, and a width of insert 50 is about 8 inches, more specifically about 8.30 inches. Each insert 50 is optionally of a height less than the height of sidewalls 25, 30, 35, 40 of pan 15, so that pans 15 with inserts 50 still within them may be stacked in a partially nested configuration. According to one embodiment, such stacking occurs after the food products are baked and removed, for example while pans 15 cool and/or await washing. In that regard, the underside of bottom 20 of an upper pan in the nested stack optionally rests on dough guides 120 of insert 50 placed in a next lower pan 15.

Method aspects according to embodiments of the invention now will be described with respect to FIGS. 5-13. A method of making multiple pizzas includes placing insert or support 50 into cooking vessel 15, for example into the standard generally rectangular baking pan referenced above. The method further includes placing dough 150 across support 50, indicated by arrows 155 in FIG. 5. FIG. 5 illustrates two dough sheets, or disks, 150 placed across two supports 50 placed in two pans 15, for production of four separate pizzas. According to other embodiments, other numbers of inserts 50 and pans 15, for example one, three, or four, are used to produce other numbers of pizzas, for example two, six or eight. Further, although illustrated dough sheets 150 are generally rectangular in shape to match the generally rectangular shape of inserts 50, other shapes of dough sheets are also contemplated, for example generally circular, generally square, generally triangular, generally polygonal, and generally trapezoidal shapes. Food release or other non-stick agent optionally is applied to pan 15 and/or insert 50 before placement of dough 150.

Upon placement onto supports 50, dough sheets 150 are generally frozen, and/or at least partially frozen, according to embodiments of the invention. Sheets 150 thus are generally stiff and retain their shape upon placement onto supports 50. To the extent that original placement of the sheets 150 or subsequent external forces de-center or otherwise dislodge dough sheets 150 with respect to support 50, dough guides 120 of support 50 and/or sidewalls 25, 35 of pan 15 serve to center sheets 150 and/or otherwise move them to a desired position.

According to embodiments of the invention, dough sheets 150 are allowed to temper, or thaw, while disposed on support 50 within pan 15. A method according to an embodiment of the invention thus includes thawing a generally frozen sheet of dough 150 on support 50. The length of thawing time is set according to characteristics of the dough and/or other physical or environmental properties associated with apparatus 10. One embodiment provides for at least about eight hours of thawing time at about 38 degrees Fahrenheit. Multiple pans 15 with supports 50 optionally are stacked on top of each other, for example with lids over each pan 15 to support the bottom of a next higher pan in the stack, in a cooler or other thawing environment.

As dough sheets 150 thaw, they settle into divisions 54, 56 and assume a shape generally corresponding to the sidewalls of support 50 and bottom 20 of pan 15, e.g. in a generally “draped” configuration. The method thus includes placing dough 150 across support 50 to form multiple dough portions 160, 165. Once the thawing process is complete, for example, the method further includes dividing dough sheets 150, such that multiple dough portions 160, 165 become separated. FIG. 6 illustrates dough roller 170, which is an example of a device used to perform the dividing. Rolling roller 170 on each dough sheet 150 along center bar 100 separates each dough sheet 150 into the separate portions 160, 165. Platform(s) 105 provide additional support and back pressure against roller 170 to aid the dividing process, as referenced earlier in this patent application. The flat area of platform(s) 105 provides room for roller 170 to travel beyond the edge of dough 150 and completely cut dough 150 to its edge.

After the dividing, the edges of portions 160, 165 extend generally to the top of each sidewall of support 50, though some sagging or other downward movement of the edges is acceptable. Positioning edges of portions 160, 165 at the top or almost at the top of the sidewalls is desirable, though not necessarily required, to better promote an appearance of multiple, separate pizzas, each with their own crust.

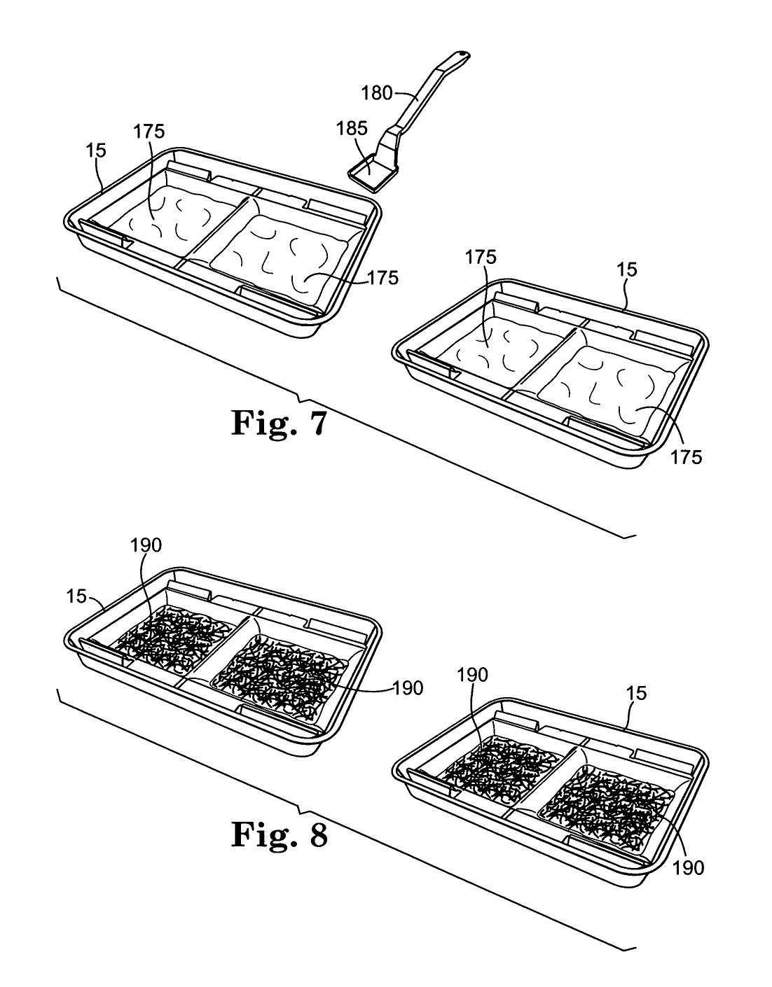

A method according to embodiments of the invention next includes placing ingredients on multiple dough portions 160, 165, to form multiple pizzas. Such ingredients optionally include pizza sauce 175, shown in e.g. FIG. 7. Sauce 175 optionally is applied by spreader 180. Spreader 180 has bowl portion 185 generally corresponding to the shape of each portion 54, 56 of support 50 and/or to the shape of multiple separate dough portions 160, 165. According to the illustrated example, bowl portion 185 is generally square-shaped, corresponding to generally square-shaped support portions 54, 56 and/or dough portions 160, 165. Each corner of bowl portion 185 is pushed or moved to a corresponding corner of each dough portion 160, 165, to spread sauce across generally the entire bottom of dough portions 160, 165, including into the corners thereof, without having to turn or lift spreader 180.

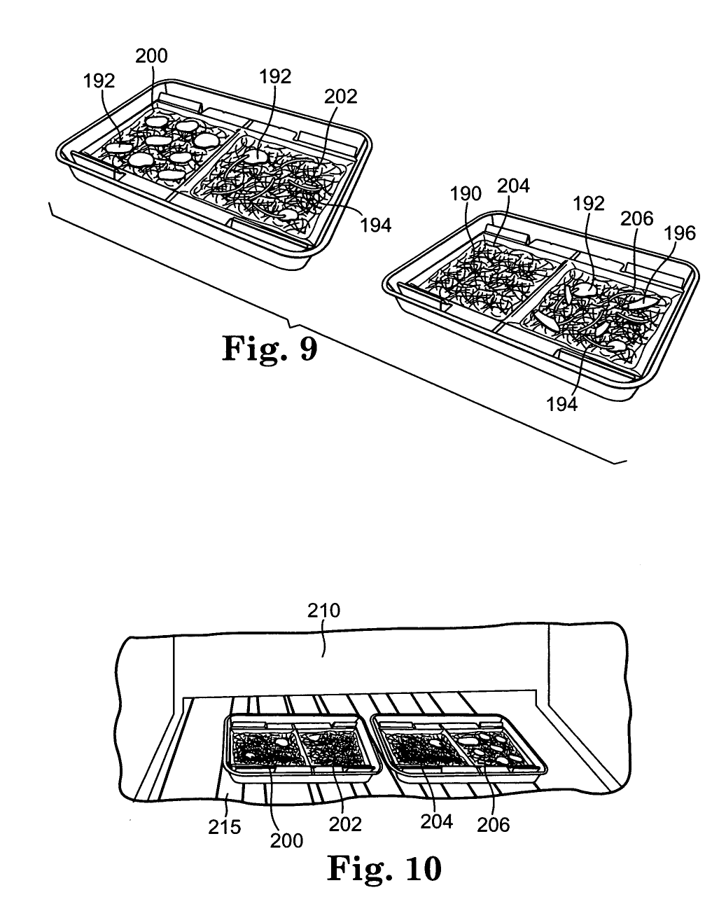

The ingredients placed on multiple dough portions 160, 165 also optionally include bottom cheese 190, illustrated in e.g. FIG. 8, and meats 192, vegetables/fruits 194, 196, top cheese, or any other food items or toppings suitable for placement on pizza products, as illustrated in e.g. FIGS. 9-10. Meats 192 optionally include pepperoni, sausage, ham, and/or bacon, to name several examples, and vegetables/fruits 194, 196 optionally include green peppers, mushrooms, black olives, and/or tomatoes, to name several examples. The placing of ingredients according to a method embodiment of the invention includes placing different types and/or combinations of ingredients on multiple dough portions 160, 165 such that multiple pizzas 200, 202, 204, 206 are of different kinds.

As illustrated in FIG. 10, a method according to an embodiment of the invention further includes placing support 50 and pan or other cooking vessel 15 into a heating environment, for example conveyor oven 210 via conveyor 215, to bake multiple pizzas 200, 202, 204, 206. The placing into a heating environment includes placing two pans or other cooking vessels 15 end-to-end, as in FIG. 10, for generally simultaneous entry into and traversal through the heating environment. Conveyor 215 conveys pans 15 into heating environment 210 in generally a width-wise or transverse direction, as illustrated. Placing pans 15 end-to-end provides a number of advantages, including more easily keeping the multiple pizzas of a single customer order together, and more easily ensuring that the multiple pizzas all are baked uniformly and for the proper amount of time. If pans 15 are placed in a direction perpendicular to that shown in FIG. 10, for example, they are more likely to be removed from a conveyor oven when only a first end has emerged from the oven, meaning that the food product at the second, trailing end might be undercooked. According to embodiments of the invention, the baking process within oven 210 occurs at a temperature in a range of about 400 degrees to about 500 degrees Fahrenheit, and more particularly about 450 degrees Fahrenheit, for a length of time in a range of about 7 minutes to about 9 minutes, and more particularly about 7.5 minutes or about 8.5 minutes.

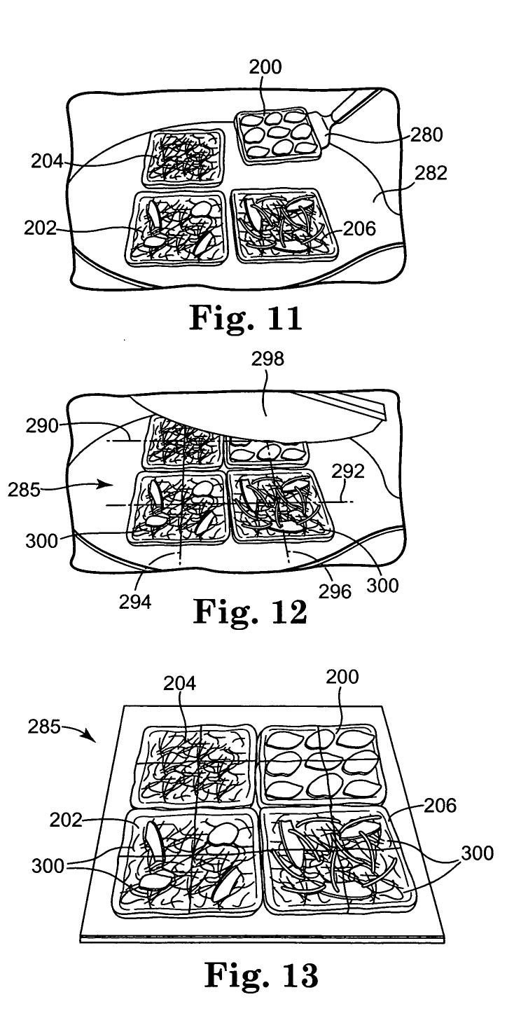

As illustrated in FIG. 11, a method according to an embodiment of the invention also includes removing multiple pizzas 200, 202, 204, 206 from supports 50 after pans 15 emerge from oven 210 or otherwise after the baking process is complete. Each of the multiple pizzas is removed from their respective portions 52, 54 of supports 50, for example using spatula or other utensil 280, and placed on peel or other support 282, for example a pizza box or pizza box insert.

In the illustrated example, each of the four multiple pizzas is placed next to an adjacent pizza to form composite pizza 285, as shown in e.g. FIG. 12. The method further includes cutting across multiple pizzas of composite pizza 285 in one or more single cutting strokes using rocker knife 298, for example, to divide the multiple pizzas into slices 300. In the illustrated example, the method includes cutting across four multiple pizzas 200, 202, 204, 206 in four cutting strokes 290, 292, 294, 296, to create sixteen individual slices 300 of pizza.

Thus, according to embodiments of the invention, a method of baking a plurality of pizzas 200, 202 and/or 204, 206 in a single pan 15 includes placing insert 50 into pan 15, placing dough 150 onto insert 50, dividing dough 150 into portions 160, 165, topping dough portions 160, 165, and baking topped dough portions 160, 165 to form a plurality of baked pizzas 200, 202 and/or 204, 206. The placing includes placing a single generally frozen dough sheet 150 onto insert 50. FIG. 13 illustrates composite pizza 285 comprising multiple individual pizzas 200, 202, 204, 206 and slices 300.

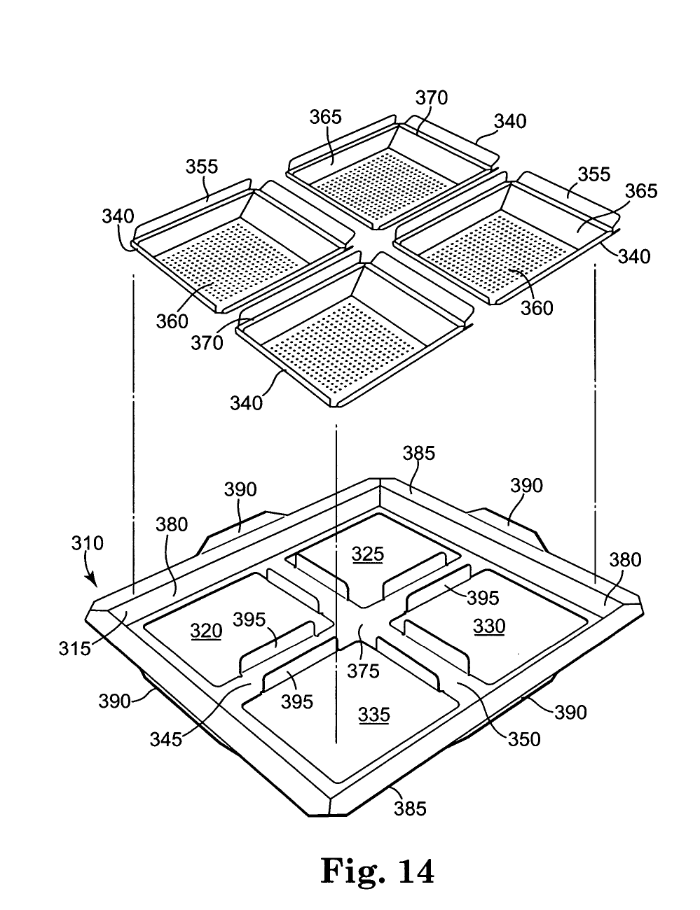

FIG. 14 illustrates an alternative embodiment. Frame 310 supports multiple food products, such as multiple pizzas. Frame 310 defines rim 315 for supporting the multiple food products. Rim 315 defines a plurality of separated bottom openings 320, 325, 330, 335, one opening for each of the food products, for transmission of thermal energy to the food products supported by rim 315. Frame 310, including rim 315, is adapted to support a plurality of separate food-product pans 340, one pan for each of the multiple food products, over each of bottom openings 320, 325, 330, 335 in frame 310. Frame 310 further defines cross-member 345 extending across frame 310 between two of the openings 320, 335 and between two of the openings 325, 330. Frame 310 also defines cross-member 350 extending between two of the openings 330, 335 and between two of the openings 320, 325.

Frame 310, also called a carrier, holder or caddie, is designed to support and accommodate four individual pizza pans 340, as illustrated. Each pan 340 fits within and is supported on a corresponding separate quadrant of frame 310. Each pan 340 defines four protruding tabs 355, which are used to aid in moving or otherwise manipulating pans 340 to or form the various quadrants of frame 310 or other locations. Each pan 340 also includes perforated bottom 360, which allows convective heat to pass directly therethrough, and upstanding sidewalls 365, which extend at an angle relative to perforated bottom 360. Lip 370 extends between each sidewall 365 and its corresponding tab 355. Tabs 355 intersect their respective lips 370 at an angle intended to minimize undesired tilting of pan 340 upon gripping by a gripper or other tool.

Frame 310 includes bottom portion 375, with four sidewalls 380 extending upwardly at an angle from bottom portion 375. That angle is optionally the same, or about the same, as that between each sidewall 365 and perforated bottom 360 of pans 340. Each sidewall 380 of frame 310 includes outwardly directed lip 385, from which tab 390 extends for manipulation by a pan gripper or other tool. Four tabs 390 are provided, according to one embodiment, one on each of the four sides of frame 310. Tabs 390 thus permit easy manipulation by a tool for insertion into or removal from an oven or other location.

Upstanding from bottom portion 375 are a plurality of frame tabs 395, for example eight frame tabs as illustrated in FIG. 14, which are constructed to act as supports for pans 340. Tabs 395 are disposed with respect to bottom portion 375 at an angle of between about 60 degrees and about 90 degrees, for example, and/or optionally to match or accommodate the angle between each sidewall 365 and bottom 360 of each pan 340. Four openings 320, 325, 330, 335 are provided, one for each of the four pans 340 supported on frame 310, according to the illustrated embodiment. Alternative embodiments contemplate additional numbers of openings and a corresponding additional numbers of pans, for example two openings and pans, six openings and pans, etc.

Pans 340 fit within frame 310. Tabs 395 of frame 310 engage corresponding sidewalls 365 and/or lips 370 of pans 340, and optionally contact the lines of intersection between sidewalls 365 and their corresponding lips 370 or areas immediately adjacent the lines. Each pair of tabs 395 for a particular quadrant of frame 310 serves to level its corresponding pan 340, to position it at the proper position on frame 310 and/or to position it properly with respect to the other pans 340 that frame 310 supports.

When one or more pans 340 are supported by frame 310, the underside of perforated bottom 360 of each pan 340 is exposed directly, through a corresponding opening 320, 325, 330, 335 in frame 310, to baking heat generated by the oven or other heating environment into which frame 310 is placed. An outer edge of each underside is supported directly on bottom portion 375 of frame 310 to cover and surround respective openings 320, 325, 330, 335. Other features according to the FIG. 14 embodiment, including method features, are described in U.S. Provisional Patent Application No. 60/446,479, incorporated by reference above.

Embodiments of the invention allow a group of pizza eaters to mix and match their favorite toppings so that each person gets his or her own individual pizza. Four different individual pizzas, topped four different ways, for example, fill a serving utensil or a pizza box corner-to-corner, in a manner similar to that of a single pizza.

Embodiments of the invention are specifically directed toward pizza-type food products. Embodiments of the invention have wide application for use in cooking and preparing other foods and food products, however, including pies, cookies, pastries, etc. Thus while certain embodiments have been described with respect to pizza, the invention is not limited to those embodiments. Additionally, those of ordinary skill will appreciate that the invention contemplates a large number of variations and modifications beyond those specifically disclosed herein, including but not limited to additional dimensions, materials, shapes, and other features not specifically described herein.

What is claimed is:

1. Apparatus for holding multiple pizzas, the apparatus comprising:
a pan; and
an insert adapted to fit within the pan, the insert comprising a plurality of sidewalls extending between a base of the insert and an upper portion of the insert, the sidewalls generally surrounding a plurality of openings defined in the base;
wherein the insert is adapted to fit within the pan such that each of the multiple pizzas contacts a bottom of the pan and the sidewalls of the insert.

2. The apparatus of claim 1, wherein the insert defines a center bar disposed above the upper portion of the insert; further wherein the center bar and the sidewalls are arranged such that a single sheet of dough laid across the insert is readily divided along the center bar to form separate crusts for the multiple pizzas.

3. The apparatus of claim 1, wherein the insert defines a generally planar platform extending in the upper portion outwardly from the sidewalls.

4. The apparatus of claim 3, further comprising a lip extending toward the base and disposed along an edge of the platform to structurally strengthen the insert.

5. The apparatus of claim 1, wherein the insert defines a plurality of dough guides adapted to generally center dough laid across the insert, the dough guides extending above the upper portion.

6. The apparatus of claim 5, wherein the insert defines a plurality of stabilizers extending from the dough guides toward the base, the stabilizers being adapted to stabilize the insert within the pan.

7. The apparatus of claim 1, wherein the insert defines a plurality of stabilizers spaced from the sidewalls and extending toward the base, the stabilizers being adapted to stabilize the insert within the pan.

8. The apparatus of claim 1, wherein the sidewalls are angled with respect to the base in a manner to create the multiple pizzas from a single sheet of dough laid across the insert.

9. The apparatus of claim 1, wherein the insert defines a generally rectangular shape; further wherein the openings are two in number and are of a generally square shape for forming two generally square pizzas.

10. A frame for supporting multiple food products, the frame defining a rim for supporting the multiple food products, the rim generally surrounding a plurality of separated bottom openings, one opening for each of the multiple food products, the openings being adapted to allow transmission of thermal energy directly to the multiple food products supported by the rim.

11. The frame of claim 10, wherein the frame is adapted for placement within a pan to directly support the multiple food products through the bottom openings.

12. The frame of claim 10, wherein the frame is adapted to support a plurality of separate food-product pans, one pan for each of the multiple food products, over each of the bottom openings.

13. The frame of claim 10, further defining a raised portion disposed between the separated bottom openings, the raised portion being adapted to aid in cutting a portion of the multiple food products.

14. An insert adapted to fit within a pan, the insert comprising:
a plurality of sidewalls extending between a base of the insert and an upper portion of the insert, the sidewalls generally surrounding a plurality of openings defined by the insert in the base;
wherein the insert is adapted to fit within a pan such that each of multiple pizzas held by the insert is able to contact a bottom of the pan and the sidewalls of the insert.

15. A method of making multiple pizzas, the method comprising:
placing a support into a cooking vessel;
placing dough across the support to form multiple dough portions;
placing ingredients on the multiple dough portions to form multiple pizzas; and
placing the support and the cooking vessel into a heating environment to bake the multiple pizzas.

16. The method of claim 15, wherein the support is a divided support, the method further comprising dividing the dough into multiple dough portions on the divided support.

17. The method of claim 16, wherein the dividing comprises rolling a roller across the dough sheet.

18. The method of claim 15, wherein the placing of dough comprises placing a generally frozen sheet of dough across the support.

19. The method of claim 18, further comprising thawing the generally frozen sheet of dough on the support.

20. The method of claim 19, wherein the support comprises multiple divisions, the method comprising settling the sheet of dough into the divisions during the thawing.

21. The method of claim 15, wherein the placing of ingredients comprises placing different types of ingredients on the multiple dough portions such that the multiple pizzas are of different kinds.

22. The method of claim 21, further comprising removing the multiple pizzas from the support after baking and combining the multiple pizzas into a single composite pizza.

23. The method of claim 22, further comprising cutting across multiple pizzas of the composite pizza in a single cutting stroke, to divide the multiple pizzas of the composite pizza into slices.

24. The method of claim 23, wherein the multiple pizzas are four in number; further comprising cutting across the four multiple pizzas in four cutting strokes to create sixteen individual slices of pizza.

25. The method of claim 15, wherein the placing into a heating environment comprises placing two of the cooking vessels end-to-end generally simultaneously into the heating environment.

26. A method of baking a plurality of pizzas in a single pan, the method comprising placing an insert into the pan, placing dough onto the insert, dividing the dough into portions, topping the dough portions, and baking the topped dough portions in the pan to form a plurality of baked pizzas.

27. The method of claim 26, wherein the placing of dough comprises placing a single generally frozen dough sheet onto the insert.

28. A composite pizza made by:
placing a support into a cooking vessel;
placing dough across the support to form multiple dough portions;
placing different types of ingredients on the multiple dough portions to form multiple pizzas of different kinds;
placing the support and the cooking vessel into a heating environment to bake the multiple pizzas;
removing the multiple pizzas from the support after baking; and
combining the multiple pizzas into a single composite pizza.

29. The pizza of claim 28, wherein the placing into a heating environment comprises placing two of the cooking vessels end-to-end generally simultaneously into the heating environment.

30. The pizza of claim 28, further comprising dividing the dough into multiple dough portions on the support.

31. A frame for supporting multiple food products, the frame defining means for supporting the multiple food products, the means for supporting defining a plurality of separated bottom openings, one opening for each of the multiple food products, the openings being adapted to allow transmission of thermal energy directly to the multiple food products supported by the rim.
